(19) United States
(12) Patent Application Publication
(10) Pub. No.: US 2018/0079533 A1
(43) Pub. Date: Mar. 22, 2018

(54) AIRCRAFT ENGINE ILLUMINATION AND DIAGNOSTIC SYSTEM

(71) Applicant: WILLIAMS INTERNATIONAL CO., L.L.C., Walled Lake, MI (US)

(72) Inventors: Mark E. SUCHEZKY, South Lyon, MI (US); Neil H. CRAFT, West Bloomfield, MI (US); Gregg G. WILLIAMS, Walled Lake, MI (US)

(73) Assignee: WILLIAMS INTERNATIONAL CO., L.L.C., Walled Lake, MI (US)

(21) Appl. No.: 15/706,514

(22) Filed: Sep. 15, 2017

Related U.S. Application Data
(60) Provisional application No. 62/395,955, filed on Sep. 16, 2016.

(51) Int. Cl. B64F 5/60; B64D 47/02; B64D 47/08; G07C 5/08

(52) U.S. Cl. CPC B64F 5/60; G07C 5/08; B64D 47/08; B64D 47/02

(57) ABSTRACT

An aircraft engine incorporates one or more externally-visible illuminators that are illuminated responsive to an activation signal. At least one of a quantity, a location, a pattern, a sequence, a color, or a color pattern of the one or more externally-visible illuminators, a control of at least one color of the one or more externally-visible illuminators, or a control of at least one intensity of the one or more externally-visible illuminators, is uniquely associated with the manufacturer of the aircraft engine, so as to provide for distinguishing the manufacturer of the aircraft engine while the aircraft engine is in operation in an aircraft.

### CROSS-REFERENCE TO RELATED APPLICATIONS

The instant application claims the benefit of prior U.S. Provisional Application Ser. No. 62/395,955 filed on 16 Sep. 2016, which is incorporated by reference herein in its entirety.

### BRIEF DESCRIPTION OF THE DRAWINGS

In the accompanying drawings:

FIG. 1 illustrates a side-profile view of an aircraft and an associated block diagram of associated first or second aspects of an aircraft engine illumination system;

FIG. 2 illustrates a perspective view of an aircraft and an associated block diagram of the associated second aspect of the aircraft engine illumination system in cooperation with an associated visually-based aircraft engine diagnostic system; and

FIG. 3 illustrates a side-profile view of an aircraft and an associated block diagram that includes an associated third aspect of an aircraft engine illumination system that can be externally controlled.

### DESCRIPTION OF EMBODIMENT(S)

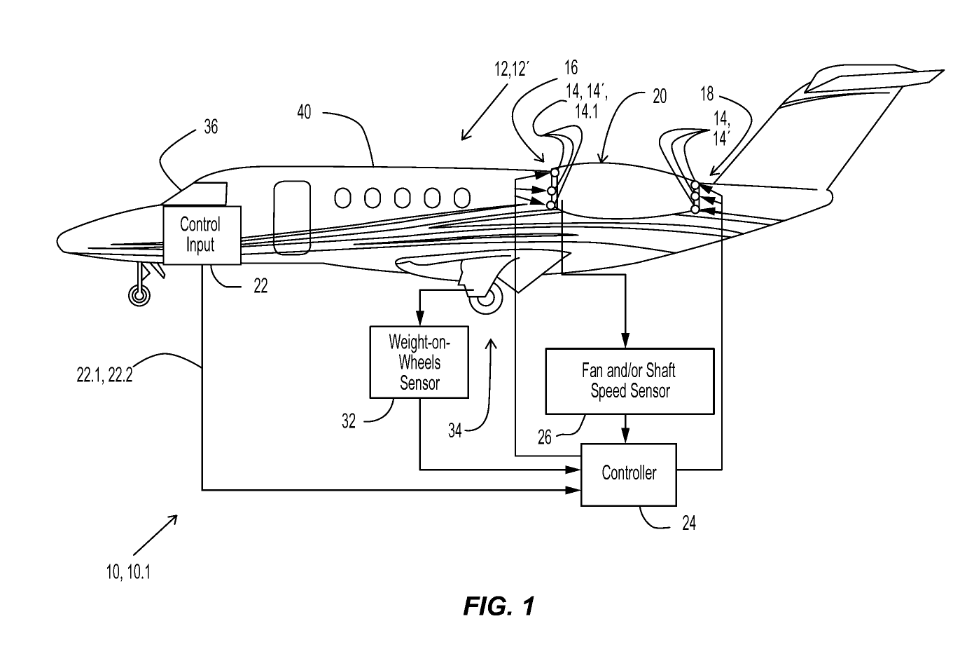

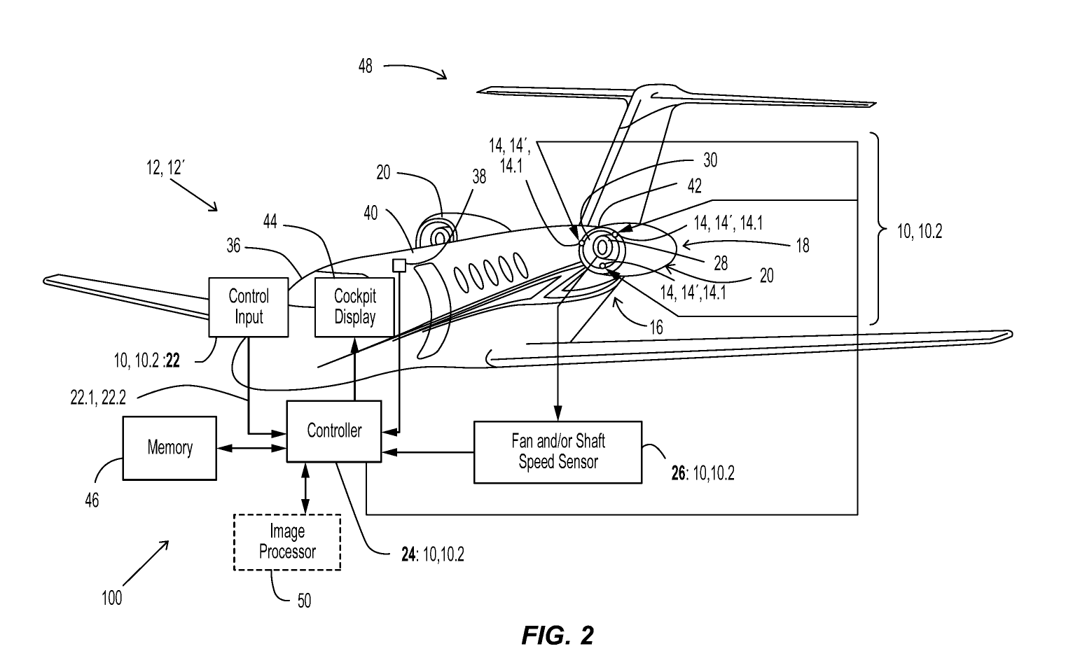

Referring to FIG. 1, a first aspect of an aircraft engine illumination system 10, 10.1—illustrated in cooperation with an associated aircraft 12—comprises one or more externally-visible illuminators 14, for example, light-emitting diodes (LEDs) 14′, for example, proximate to one or both of the inlet 16 and exhaust 18 of a jet engine 20 of the aircraft 12—or of one or more jet engines 20 of a multi-engine aircraft 12′,—so as to provide for a distinctive visual appearance of the jet engine 20 and aircraft 12, 12′ during operation thereof, particularly when operated under darkness. The aircraft engine illumination system 10, 10.1 may be either automatically activated whenever the associated jet engine 20 is in operation, or manually activated responsive to a control input 22 from the pilot of the aircraft 12, 12′. The one or more of illuminators 14, 14′ may be either monochromatic or polychromatic, with possibly controllable intensity and/or controllable color. For example, in accordance with one set of embodiments, the color or colors of the one or more illuminators 14, 14′ at the inlet 16 may differ from that of the exhaust 18; or the intensity or color of the one or more illuminators 14, 14′ may be varied under control of an associated controller 24 responsive to either an associated power level signal 22.1, or an associated engine rotational speed signal 22.2, from the control input 22, which provides a measure of the corresponding respective power level or rotational speed of the corresponding associated jet engine 20. For example, the engine rotational speed signal 22.2 could be provided by an associated fan and/or shaft speed sensor 26 that provides a measure of the rotational speed of the visible first fan stage 28 (illustrated in FIG. 2) of the corresponding associated jet engine 20. As another example, in accordance with another set of embodiments, the color or colors, or the pattern or illumination sequence thereof, of the one or more illuminators 14, 14′ may be set by either the operator, the manufacturer of the aircraft 12, or the manufacturer of the aircraft powerplant with which the illuminators 14, 14′ are associated. For example, the arrangement of the illuminators 14, 14′, and possibly the associated color thereof, could be representative of an associated trademark.

Each illuminator 14 generally consists of an electrically-driven light-illuminating element, for example, an aforementioned light-emitting diode (LEDs) 14′, or a gaseous device such as a plasma-generated light source or a flash tube. The illuminators 14 may be oriented so as to emit light either primarily outwards from the jet engine 20; inwards towards externally-visible internal components of the jet engine 20, such as the first fan stage 28; or a combination thereof. The one or more illuminators 14 may be located anywhere along the outside of the jet engine 20 or within the inlet duct 30 thereof in order to either provide a distinctive pattern of illumination, or to provide for illuminating externally-visible internal components of the jet engine 20. For example, in addition to the inlet 16 and/or exhaust 18 of the jet engine 20, one or more illuminators 14 could be located along or proximate to an associated bypass duct of the jet engine 20. For multi-engine aircraft 12′, each jet engine 20 thereof could be outfitted—as described hereinabove—with the one or more illuminators 14.

In accordance with one set of embodiments for which the one or more of illuminators 14 are oriented so as to provide for illuminating an externally-visible rotating component of the jet engine 20—for example, the first fan stage 28—the speed of the rotating element may be sensed by an associated rotational speed sensor 26 and provided to the controller 24 so as to provide for the controller 24 to strobe the one or more of illuminators 14 in synchronism with the associated rotating component, so as to provide for controlling the perceived rotational speed of the rotating element, as perceived by an external observer. For example, in the embodiment illustrated in FIG. 1, a fan and/or shaft speed sensor 26 senses the rotational speed of the externally-visible first fan stage 28 and provides a measure thereof to the controller 24, which in turn strobes the associated inlet-fan illuminators 14, 14′, 14.1 in synchronism with the first fan stage 28 so as to provide for giving a perception to an observer that the first fan stage 28 is either stationary (i.e. frozen or “freeze-frame”), or slowly rotating in either a forward or reverse direction, for example, responsive to an illumination mode that is either manually selected by the pilot as a control input 22 to the controller 24, or automatically determined responsive to an operating condition of the aircraft 12, 12′ or an operating condition of the associated jet engine 20.

Generally, the illumination mode (i.e. the pattern or timing of activations, intensities, and colors of the associated one or more illuminators 14) can be either manually selected or set by the pilot via the associated control input 22, or can be automatically determined responsive to an operating condition of the aircraft 12, 12′ or an operating condition of the associated jet engine 20. For example, in accordance with one mode of operation, the aircraft engine illumination system 10, 10.1 is activated only when the aircraft 12, 12′ is on the ground, for example, responsive to a signal from a weight-on-wheels sensor 32 that detects from the landing gear 34 of the aircraft 12, 12′ whether or not the aircraft 12, 12′ is airborne, so as to avoid a potential confusion or distraction to other aircraft when in flight. For example, in accordance with one mode of operation, an operator (e.g. pilot) of the aircraft 12, 12′ could, e.g. by a manual control input 22 to the controller 24, cause the illuminators 14, 14′ to flash or operate in a particular attention-grabbing sequence when either crossing, entering, or operating along an active runway or taxiway, so as to provide for preventing or avoiding a collision with another aircraft.

The first aspect of an aircraft engine illumination system 10, 10.1—if associated exclusively with a jet engine 20 manufactured by a particular manufacturer—when used in a given aircraft 12, 12′, provides a public notice that the particular manufacturer's jet engine 20 is being used in that aircraft 12, 12′, so as to either have the effect of a “trademark” of that manufacturer's jet engine 20, or to explicitly represent a trademark—registered or not—of the manufacturer of the jet engine 20

Referring also to FIG. 2, a second aspect of an aircraft engine illumination system 10, 10.2 is used to determine whether or not there are any visually-perceivable problems with the jet engine 20 during operation thereof in the aircraft 12, 12′. More particularly, in an aircraft 12, 12′ for which the inlet 16 of the jet engine 20 is viewable by the pilot or an observer from the cockpit 36 of the aircraft 12, 12′, the second aspect of an aircraft engine illumination system 10, 10.2 comprises a set of one or more inlet-fan illuminators 14, 14′, 14.1 associated with the inlet 16 of the jet engine 20, and further comprises: a controller 24 that provides for controlling the activation of the set of one or more inlet-fan illuminators 14, 14′, 14.1; a fan and/or shaft speed sensor 26 that provides for sensing the rotational speed of the first fan stage 28 and providing a signal responsive thereto to the controller 24; and a control input 22 to the controller 24 that provides for operator control of the aircraft engine illumination system 10, 10.2. The one or more inlet-fan illuminators 14, 14′, 14.1 are configured and oriented so as to provide for illuminating the first fan stage 28 at sufficient intensity for viewing thereof with sufficient resolution and clarity to make a diagnosis from the cockpit 36 of the aircraft 12, 12′. The fan and/or shaft speed sensor 26 senses the rotational speed of the externally-visible first fan stage 28 and provides a measure thereof to the controller 24, which in turn strobes the associated inlet-fan illuminators 14, 14′, 14.1 in synchronism with the first fan stage 28 so as to provide for giving a perception to an observer that the first fan stage 28 is either stationary (i.e. frozen or “freeze-frame”), or slowly rotating in either a forward or reverse direction, responsive to, and depending upon, a control-input signal from the control input 22. Accordingly, a pilot or observer in the cockpit 36 of the aircraft 12, 12′ can view the inlet 16 and first fan stage 28 of jet engine 20 and use the control input 22 to view either a stationary or slowly rotating image first fan stage 28 to provide for visual inspection for one or more of the following conditions: ice buildup on, or Foreign Object Damage (FOD) to, externally-visible stationary (e.g. engine lip and stationary vanes) or rotating (e.g. blades of first fan stage 28) portions of the jet engine 20; fuel or hydraulic leaks; or other mechanical problems or issues.

For a first fan stage 28 rotating at RPS revolutions per second, the first fan stage 28 can be made to appear stationary or slowly rotating forward or backwards relative to a particular rotationally-indexed position of the first fan stage 28, if the time period between strobes of the inlet-fan illuminators 14, 14′, 14.1 is set to AtE as given by:

$$Δ {t}_{E} = \frac{N + δ}{RPS} \qquad ( 1 )$$

where N is an integer, and |δ|<1. If δ=0, the first fan stage 28 will appear to be stationary and rotationally indexed at the same position for each strobe; if δ>0, the first fan stage 28 will appear to rotate forwards; and if δ<0, the first fan stage 28 will appear to rotate backwards. The first fan stage 28 can be made to appear quasi-stationary or slowly rotating forward or backwards relative thereto, but without necessarily-consistent rotational indexing of the first fan stage 28 for different strobe times, if the time period between strobes of the inlet-fan illuminators 14, 14′, 14.1 is set to Δt_{Q} as given by:

$$Δ {t}_{Q} = \frac{N + δ}{RPS \cdot {N}_{Blades}} \qquad ( 2 )$$

where N_{Blades} is the integral number of blades of the first fan stage 28.

Referring to FIG. 2, the above-described second aspect of the aircraft engine illumination system 10, 10.2 can operate as part of an associated aircraft engine diagnostic system 100 that provides for capturing one or more images or videos of the jet engine 20 that can be used to determine whether or not there are any visually-perceivable problems with the jet engine 20 during operation thereof in the aircraft 12, 12′, regardless of whether or not the portions of the jet engine 20 to be viewed are visible from the cockpit 36 of the aircraft 12, 12′. More particularly, in addition to the above-described elements of the second aspect of the aircraft engine illumination system 10, 10.2, the aircraft engine diagnostic system 100 further incorporates one or more cameras 38 located either on the fuselage 40 of the aircraft 12, 12′, or on the nacelle 42 or inlet duct 30 of the associated jet engine 20, in direct view of the portion of the jet engine 20 to be studied, wherein images are captured by the one or more cameras 38 in synchronism with the rotating first fan stage 28 of the jet engine 20, and possibly also in synchronism with the associated illumination from the associated illuminators 14, 14′. For example, in the embodiment illustrated in FIG. 2, the one or more cameras 38 is/are located on the fuselage 40, for example, possibly aft of the cockpit 36, and in direct view of the inlet 16 and associated first fan stage 28 of the jet engine 20. The above-described second aspect of the aircraft engine illumination system 10, 10.2 provides for illuminating the portion of the jet engine 20 being viewed by the one or more cameras 38, and the image(s) captured by the one or more cameras 38 under control of the controller 24 are displayed on a cockpit display 44 for view by either a pilot or observer in the cockpit 36 of the aircraft 12, 12′, in order to provide for visual inspection of the jet engine 20 for the above-described conditions. The image(s) captured by the one or more cameras 38 under control of the controller 24 may also be stored in memory 46 for later analysis, for example, as part of a maintenance record of the jet engine 20 or for accident investigation. Furthermore, the image(s) captured by the one or more cameras 38 under control of the controller 24 may also be transmitted via a wireless link to a ground station for independent analysis—either in real time or at a later time—and/or for storage.

With the inlet-fan illuminators 14, 14′, 14.1 strobed at an interval Δt_{E} from equation (1) with δ=0 each resulting image captured by the one or more cameras 38 would show the first fan stage 28 at a uniformly-rotationally-indexed position so that each portion of the image provides for analyzing the same portion of the first fan stage 28 at different times and over time, which may be compared with a stored reference image to look for differences that might result from icing, Foreign Object Damage (FOD), fluid leakage, or other causes. Alternatively, e.g. when using continuous illumination; or additionally, e.g. in synchronism with the strobed illumination, the images could be synchronized with the rotation of the jet engine 20 by alternately opening and closing a shutter or light valve associated with the camera at the interval Δt_{E} from equation (1).

Alternatively, or additionally, one or more cameras 38 may be located on the fuselage 40 or tail 48 of the aircraft 12, 12′ in view of the exhaust 18 of the jet engine 20, which together with associated illuminators 14, 14′, provide for inspecting for, or detecting, a malfunction of the jet engine 20 from that perspective.

Yet further alternatively, or additionally, one or more cameras 38 may be located on, or in, the jet engine 20, together with associated illuminators 14, 14′, to provide for inspecting internal portions thereof during operation of the aircraft 12, 12′, for example, aft of the first fan stage 28 where ice is known to accrete, e.g. on a core of an associated bypass splitter; in an associated bypass duct; or under the nacelle 42; in order to provide for inspecting for, or detecting, ice accumulation, fluid leaks, Foreign Object Damage (FOD), or other damage or malfunction.

Yet further alternatively, or additionally, the one or more cameras 38 and associated illuminators 14, 14′ may be adapted to generate and sense light at one or more invisible wavelengths that provide for enhance sensitivity to the material being sensed. For example, one or more infrared cameras 38′ and illuminators 14, 14′ may be used to inspect for ice and to obtain images in inclement conditions when the inlet air has snow, ice crystals or rain. Furthermore, ultraviolet wavelengths may be used to inspect for leakage of fluids containing a UV leak detection dye. Furthermore, aircraft engine diagnostic system 100 could incorporate one or more night-vision cameras 38, 38″.

In one set of embodiments, the illuminators 14, 14′, 14.1 and one or more cameras 38 are mounted so as to minimize or reduce disruption of associated aerodynamic drag, and to minimize or reduce susceptibility to icing or Foreign Object Damage (FOD), for example, by flush mounting and/or by use of associated supplemental heating to prevent localized ice accumulation. Flush-mounted cameras 38 or illuminators 14, 14′, 14.1 may incorporate, or cooperate with, associated lenses or other optical elements that provide for an associated field-of-view that is biased towards the object being viewed by the camera(s) 38.

In accordance with one set of embodiments, the controller 24 may be supplemented with an associated image processor 50—either on board the aircraft 12, 12′ or at another location, for example, a ground station, another aircraft, or a satellite—to provide for either preprocessing the image—for example, with edge enhancement or adjustment of image intensity or color;—or for analyzing the image to automatically detect one or more of the aforementioned problems—for example, by segmenting the image of the first fan stage 28 into associated image segments corresponding to each associated fan blade, and analyzing the profile and/or area of each fan blade image segment to detect changes that might result from ice buildup or Foreign Object Damage (FOD).

Alternatively, or additionally, the image processor 50 could provide for pilot-or-observer-controlled selection, pan and/or zoom of the image(s) from the one or more cameras 38 displayed on the cockpit display 44, so as to provide for a more detailed inspection of particular regions of interest. Furthermore, in respect of the imaging of a rotating component, for example, the first fan stage 28, either the image processor 50 could provide for rotating the image so as to provide for positioning the image of a particular blade of interest in a particular, consistent orientation on the cockpit display 44, for example, vertically up; or the inlet-fan illuminators 14, 14′, 14.1, or camera shutter(s) or light valve(s), could be strobed so as to provide for controlling the orientation of the image on the cockpit display 44. Yet further, the fan and/or shaft speed sensor 26 may be adapted to provide for detecting or generating an index signal that provides for rotationally indexing the first fan stage 28 or associated shaft, so as to provide for associating particular blades of the first fan stage 28 with corresponding particular portions, or orientations, of the associated image displayed on the cockpit display 44. For example, if the inlet-fan illuminators 14, 14′, 14.1, or camera shutter(s) or light valve(s), are strobed in accordance with equation (1)—with δ=0 so that the image is stationary,—then in cooperation with the above-described index signal, the orientation of the resulting image on the cockpit display 44 of the first fan stage 28 may be adjusted—either continuously, or incrementally by blade—by the pilot or observer to control which of the blades of the first fan stage 28 is oriented in a selected orientation, e.g. vertically-up. As another example, if the inlet-fan illuminators 14, 14′, 14.1, or camera shutter(s) or light valve(s), are strobed in accordance with equation (2)—with δ=0 so that the image on the cockpit display 44 is stationary,—then the image of a particular blade of the first fan stage 28 may be displayed in the selected orientation, e.g. vertically-up, by simply initially changing the value of N in equation (2), for example, over the range of N₀ to N₀+N_{Blades}, where N₀ is an integer, which, in cooperation with the above-described index signal, provides for the pilot or observer to select—by blade ID—any particular blade of the first fan stage 28 for display on the cockpit display 44 in the selected orientation, which display may be further panned and/or zoomed by the pilot or observer; and then strobingin accordance with equation (1)—to maintain the selected blade in the selected postion. Accordingly, if a particular problem is observed with a particular blade of the first fan stage 28, the above-described features provide for selectively monitoring this particular blade over time to see whether or not there is a progressive deterioration thereof that might warrant further action.

Accordingly, the aircraft engine illumination system 10, 10.2 and/or associated aircraft engine diagnostic system 100 provides for improving aircraft safety by enabling the pilot or an associated observer to monitor—either by direct observation, or using images recorded by one or more cameras 38—the one or more jet engines 20 of an aircraft 12, 12′ during operation thereof, with associated illumination form one or more illuminators 14, 14′ under low-light conditions.

As used herein, the term jet engine 20 is intended to include any nacelle or tail pipe that might be associated therewith. Furthermore, although the aircraft engine illumination systems 10, 10.1, 10.2 and aircraft engine diagnostic system 100 have been illustrated in the context of an aircraft 12, 12′ powered by one or more jet engines 20, it should be understood that the type of aircraft powerplant is not limiting, and that these systems 10.1, 10.2, 100 could be applied to aircraft powered by any type of powerplant, for example, airplanes, helicopters or drones—piloted directly or remotely, or autonomously—powered by one or more turbo-fan, turbo-jet, or turbo-shaft engines with any number of associated shafts, or some other type of powerplant, for example, further including, but not limited to, internal combustion engines or electric motors. Accordingly, any reference hereinabove to jet engine 20 is intended to refer to any type of aircraft powerplant for any type of aircraft 12. For example, the above-described “freeze-frame” functionality of these systems 10.1, 10.2, 100 can be used provide for a stationary view of the propeller(s) or rotor(s) of associated propeller- or rotor-driven aircraft, and, for systems 10.2, 100, to provide for inspecting for ice accumulation, Foreign Object Damage (FOD) or other damage or malfunction of the associated propeller(s) or rotor(s).

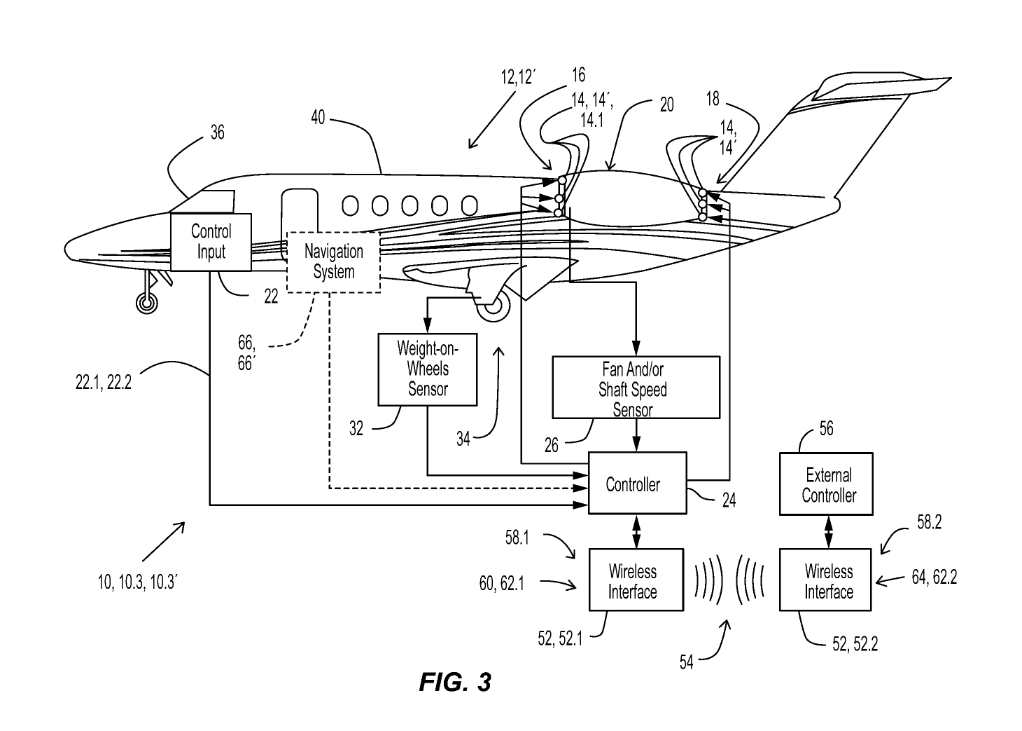

Referring to FIG. 3, a third aspect of an aircraft engine illumination system 10, 10.3 is an extension of the above-described first aspect aircraft engine illumination system 10, 10.1 that includes a means for externally controlling—via an associated wireless interface 52—the operation of the associated externally-visible illuminators 14, 14′, responsive to a wireless signal 54 from an external controller 56—for example, either a control tower during ground operation, or another aircraft while in flight—when the aircraft 12, 12′ is operated proximate thereto, so as to provide for identifying the aircraft 12, 12′ to the external controller 56. More particularly, the aircraft engine illumination system 10, 10.3 incorporates a first wireless interface 52.1 comprising a first antenna 58.1 and either a receiver 60 or a first transceiver 62.1 operatively coupled to the controller 24 that provides for receiving the wireless signal 54 from either a transmitter 64 or a second transceiver 62.2 via an associated second antenna 58.2 at the external controller 56. For example, in accordance with a first aspect, the transmitter 64 or second transceiver 62.2 encodes the wireless signal 54 for automatic recognition by the receiver 60 or first transceiver 62.1—for example, with a code associated with the tail number of the aircraft 12, 12′,—which following receipt and recognition by the receiver 60 or first transceiver 62.1 causes the controller 24 to automatically control the operation of the one or more illuminators 14, 14′—for example, to flash the intensity and/or color thereof so as to provide for an operator associated with the external controller 56 to recognize the aircraft 12, 12′ during nighttime operation. As another example, in accordance with a second aspect, the external controller 56 can communication either via the wireless interface 52 or via a conventional aircraft radio channel to request that the operator of the aircraft 12, 12′—i.e. the pilot or copilot—manually cause the controller 24 to control the operation of the one or more illuminators 14, 14′—for example, to flash the intensity and/or color thereof so as to provide for an operator associated with the external controller 56 to recognize the aircraft 12, 12′ during nighttime operation. As yet another example, in accordance with a third aspect, the aircraft 12, 12′ incorporates a navigation system 66, for example, a GPS navigation system 66′, that provides a navigation signal to the controller 24 with the location of the aircraft 12, 12′, which is then communicated via the wireless signal 54 over the wireless interface 52 to the external controller 56 so as to provide for associating the visual identification of the flashing illuminators 14, 14′ of the aircraft 12, 12′ responsive to the first or second aspect, with the exact location of the aircraft 12, 12′ from the associated navigation signal.

Either additionally, or alternatively, an alternative aspect of the aircraft illumination system 10, 10.3′ may also, or instead, cooperate with associated one or more externally-visible illuminators 14, 14′ that are associated, e.g. operatively coupled to, other portions of the aircraft 12, 12′, for example, to the fuselage, wings or empennage thereof, but otherwise structured and operative in accordance with the above-described third aspect aircraft engine illumination system 10, 10.3.

While specific embodiments have been described in detail in the foregoing detailed description and illustrated in the accompanying drawings, those with ordinary skill in the art will appreciate that various modifications and alternatives to those details could be developed in light of the overall teachings of the disclosure. It should be understood, that any reference herein to the term “or” is intended to mean an “inclusive or” or what is also known as a “logical OR”, wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. Furthermore, it should also be understood that the indefinite articles “a” or “an”, and the corresponding associated definite articles “the’ or “said”, are each intended to mean one or more unless otherwise stated, implied, or physically impossible. Yet further, it should be understood that the expressions “at least one of A and B, etc.”, “at least one of A or B, etc.”, “selected from A and B, etc.” and “selected from A or B, etc.” are each intended to mean either any recited element individually or any combination of two or more elements, for example, any of the elements from the group consisting of “A”, “B”, and “A AND B together”, etc. Yet further, it should be understood that the expressions “one of A and B, etc.” and “one of A or B, etc.” are each intended to mean any of the recited elements individually alone, for example, either A alone or B alone, etc., but not A AND B together. Furthermore, it should also be understood that unless indicated otherwise or unless physically impossible, that the above-described embodiments and aspects can be used in combination with one another and are not mutually exclusive. Accordingly, the particular arrangements disclosed are meant to be illustrative only and not limiting as to the scope of the invention, which is to be given the full breadth the appended claims, and any and all equivalents thereof.

What is claimed is:

1. A method of distinguishing the manufacturer of an aircraft engine when in operation in an aircraft, comprising:
a. receiving an activation signal; and
b. responsive to said activation signal, illuminating one or more externally-visible illuminators associated with, and fixedly-mounted to, the aircraft engine of the aircraft, wherein at least one of a quantity, a location, a pattern, a sequence, a color, or a color pattern of said one or more externally-visible illuminators, a control of at least one color of said one or more externally-visible illuminators, or a control of at least one intensity of said one or more externally-visible illuminators, is uniquely associated with the manufacturer of said aircraft engine.

2. A method of distinguishing the manufacturer of an aircraft engine when in operation in an aircraft as recited in claim 1, wherein said activation signal provides for activating said one or more externally-visible illuminators only when said aircraft engine is in operation in said aircraft and when said aircraft is operating on ground.

3. A method of distinguishing the manufacturer of an aircraft engine when in operation in an aircraft as recited in claim 1, wherein at least one of said one or more externally-visible illuminators comprises either at least one LED, at least one plasma light source, or at least one flash lamp.

4. A method of distinguishing the manufacturer of an aircraft engine when in operation in an aircraft as recited in claim 1, wherein at least one said one or more externally-visible illuminators is located either outside of said aircraft engine, within an inlet duct of said aircraft engine, or proximate to at least one of an exhaust duct or a bypass duct of said aircraft engine.

5. A method of distinguishing the manufacturer of an aircraft engine when in operation in an aircraft as recited in claim 1, wherein an illumination by at least one said one or more externally-visible illuminators is directed towards an externally-visible rotating element of, or associated with, said aircraft engine.

6. A method of distinguishing the manufacturer of an aircraft engine when in operation in an aircraft as recited in claim 5, wherein said illumination by said at least one said one or more externally-visible illuminators is emitted from a location on or proximate to a nacelle of said aircraft engine.

7. A method of distinguishing the manufacturer of an aircraft engine when in operation in an aircraft as recited in claim 5, wherein said illumination by said at least one said one or more externally-visible illuminators provides for illuminating either a fan or rotor of a gas turbine aircraft engine, or a propeller driven either by a turbo-shaft gas turbine aircraft engine or by an internal combustion aircraft engine.

8. A method of distinguishing the manufacturer of an aircraft engine when in operation in an aircraft as recited in claim 1, further comprising controlling at least one of said at least one intensity or said color of at least one of said one or more externally-visible illuminators is responsive to either a rotational speed or a power level of said aircraft engine.

9. A method of distinguishing the manufacturer of an aircraft engine when in operation in an aircraft as recited in claim 1, wherein said one or more externally-visible illuminators comprises a plurality of externally-visible illuminators, further comprising controlling said pattern of illumination by said plurality of externally-visible illuminators.

10. A method of distinguishing the manufacturer of an aircraft engine when in operation in an aircraft as recited in claim 1, wherein said one or more externally-visible illuminators comprises a plurality of externally-visible illuminators, further comprising controlling a sequence or timing of illumination by said plurality of externally-visible illuminators.

11. A method of distinguishing the manufacturer of an aircraft engine when in operation in an aircraft as recited in claim 1, further comprising: sensing a rotational speed or position of a rotating element of said aircraft engine so as to generate a corresponding rotational speed or position signal; and activating at least one of said one or more externally-visible illuminators in synchronism with said rotational speed or position signal.

12. A method of distinguishing the manufacturer of an aircraft engine when in operation in an aircraft as recited in claim 11, wherein the operation of activating said at least one of said one or more externally-visible illuminators in synchronism with said rotational speed or position signal provides for an appearance of said rotating element to be either stationary, or slowing rotating either forwards or backwards.

13. A method of distinguishing the manufacturer of an aircraft engine when in operation in an aircraft as recited in claim 1, further comprising controlling at least one of an intensity or a color of at least one of said one or more externally-visible illuminators responsive to wirelessly-communicated signal from an external controller, so as to provide for identifying said aircraft to said external controller.

14. A method of distinguishing the manufacturer of an aircraft engine when in operation in an aircraft as recited in claim 1, further comprising controlling at least one of said at least one intensity or said at least one color of at least one of said one or more externally-visible illuminators in accordance with a flashing sequence so as to provide for alerting other aircraft to the presence of said aircraft in order to prevent a collision between said aircraft and said other aircraft

15. A method of distinguishing the manufacturer of an aircraft engine when in operation in an aircraft as recited in claim 1, further comprising: sensing a rotational speed or position of a rotating element of said aircraft engine so as to generate a corresponding rotational speed or position signal; and capturing, with a camera, at least one image of said rotating element illuminated by said one or more externally-visible illuminators, wherein the operation of capturing said at least one image of said rotating element is in synchronism with said rotational speed or position signal.

16. A method of distinguishing the manufacturer of an aircraft engine when in operation in an aircraft as recited in claim 15, wherein said camera is mounted on a fuselage, a wing or a tail of said aircraft.

17. A method of distinguishing the manufacturer of an aircraft engine when in operation in an aircraft as recited in claim 15, wherein said camera is mounted on a nacelle or within an inlet duct of said aircraft engine.

18. A method of distinguishing the manufacturer of an aircraft engine when in operation in an aircraft as recited in claim 15, wherein said camera is either flush mounted to, or recessed within, an adjacent surface of either said aircraft engine or said aircraft.

19. A method of distinguishing the manufacturer of an aircraft engine when in operation in an aircraft as recited in claim 18, further comprising selectively heating a region proximate to said camera as necessary to prevent accumulation of ice on a surface adjacent thereto when said aircraft is operated during prospective icing conditions.

20. A method of distinguishing the manufacturer of an aircraft engine when in operation in an aircraft as recited in claim 15, wherein at least one of said one or more externally-visible illuminators emits infrared illumination so as to provide for imaging through at least one of rain, snow or fog.

21. A method of distinguishing the manufacturer of an aircraft engine when in operation in an aircraft as recited in claim 15, wherein at least one of said one or more externally-visible illuminators emits UV illumination so as to provide for fluorescing a substance to be detected.

22. A method of distinguishing the manufacturer of an aircraft engine when in operation in an aircraft as recited in claim 15, further comprising displaying said at least one image of said rotating element, or portion thereof, on a display within said aircraft.

23. A method of distinguishing the manufacturer of an aircraft engine when in operation in an aircraft as recited in claim 22, further comprising displaying a blade or propeller portion of said rotating element on said display, and at least one of providing for either selecting which said blade or propeller portion of a plurality of blade or propeller portions is displayed, or providing for different blade or propeller portions of said plurality of blade or propeller portions to be automatically displayed on said display in sequence over time.

24. A method of distinguishing the manufacturer of an aircraft engine when in operation in an aircraft as recited in claim 15, further comprising automatically detecting a change in a profile of at least one blade or propeller responsive to either an accumulation of ice thereon, foreign object damage thereto, or a fracture thereof.

25. A method of distinguishing the manufacturer of an aircraft engine when in operation in an aircraft as recited in claim 15, further comprising transmitting said at least one image of said rotating element to a ground station for processing or analysis.

26. A method of distinguishing the manufacturer of an aircraft engine when in operation in an aircraft as recited in claim 15, further comprising storing said at least one image of said rotating element for subsequent processing or analysis.

27. A method of providing for distinguishing the manufacturer of an aircraft engine when in operation in an aircraft, comprising:
a. providing for receiving an activation signal; and
b. responsive to said activation signal, providing for illuminating one or more externally-visible illuminators associated with, and fixedly-mounted to, the aircraft engine of the aircraft, wherein at least one of a quantity, a location, a pattern, a sequence, a color, or a color pattern of said one or more externally-visible illuminators, a control of at least one color of said one or more externally-visible illuminators, or a control of at least one intensity of said one or more externally-visible illuminators, is uniquely associated with the manufacturer of said aircraft engine.
